(19) United States
(12) Patent Application Publication
(10) Pub. No.: US 2015/0046468 A1
(43) Pub. Date: Feb. 12, 2015

(54) RANKING LINKED DOCUMENTS BY MODELING HOW LINKS BETWEEN THE DOCUMENTS ARE USED

(71) Applicant: Alcatel Lucent, Paris (FR)

(72) Inventor: Dohy Hong, Fontenay sous Bois (FR)

(73) Assignee: Alcatel Lucent, Paris (FR)

(21) Appl. No.: 13/964,507

(22) Filed: Aug. 12, 2013

(51) Int. Cl. G06F 17/30

(52) U.S. Cl. CPC G06F 17/30882
USPC 707/748

(57) ABSTRACT

Systems and methods are provided for ranking linked documents (e.g., web pages on the Internet) by modeling how users are expected to use links between the documents. One embodiment is a system that includes a memory and a controller. The memory stores probabilities for documents that each indicate a likelihood of using a link at a document to view another document. The controller is able to assign an initial value to each document, and for each document that has a value greater than a cutoff amount, to diffuse the value from the document to other documents based on the probabilities. The controller is further able to rank the documents based on an amount of value that was diffused from each document, and to process the documents based on their ranks.

### FIELD OF THE INVENTION

The invention relates to the field of databases, and to ranking linked documents by order of importance.

### BACKGROUND

Search engines are computer systems that can quickly and accurately provide information in response to queries from a user. For example, Google implements a search engine that provides a list of web pages in response to a user's query. If the user types in “cooking”, then a list of popular cooking web pages are provided. Similarly, if the user types in “fracking”, then a list of web pages that discuss natural gas technologies is provided. The ranking of a given web page is based off of the perceived importance of that web page. The perceived importance of each web page is in turn determined based upon the links between that web page and other web pages. Similar techniques can be used for documents in linked databases ranging from the entire Internet to a locally stored Structured Query Language (SQL) database.

Some companies use Search Engine Optimization (SEO) in order to artificially boost the importance of a web page in search results. This reduces the accuracy of the search engine in responding to users' queries. For example, a common SEO strategy is to create a “link farm,” which is a series of websites that each appear to be independent but are all owned and operated by the same entity. Each website on the link farm links to other websites on the link farm. Since the websites within the link farm have a substantial number of incoming and outgoing links pointing to each other, they appear to be more important than other websites that may be equally relevant to a user's query.

Link farming and other SEO techniques are generally frowned upon by search engine providers, because by artificially inflating the scores of websites, SEO techniques degrade the overall quality of web page ranking systems. Therefore search engine providers continue to seek out new techniques for improving their ranking systems in order to reduce the impact of SEO on search quality.

### SUMMARY

Embodiments described herein implement new techniques for ranking linked documents (e.g., web pages on the Internet) by modeling how users are expected to use links between the documents.

One embodiment is a system that includes a memory and a controller. The memory stores probabilities for documents that each indicate a likelihood of using a link at a document to view another document. The controller is able to assign an initial value to each document, and for each document that has a value greater than a cutoff amount, to diffuse the value from the document to other documents based on the probabilities. The controller is further able to rank the documents based on an amount of value that was diffused from each document, and to process the documents based on their ranks.

In a further embodiment, the controller is further able to diffuse value from a document by reducing the value of the document by the cutoff amount, and increasing values of documents linked to the document by a total that is not greater than the cutoff amount.

In a further embodiment, the controller is further able to iteratively repeat diffusing value from the documents until each document has a value less than the cutoff amount.

In a further embodiment, the controller is able to diffuse the value from the document to other documents by reducing the value of the document by the cutoff amount, and for each other document, identifying a probability of using a link at the document to view the other document, and increasing the value of the other document by the probability multiplied by the cutoff amount.

In a further embodiment, the sum total of the probabilities of using a link at a document to view each other document add up to a value of less than or equal to one.

In a further embodiment, the initial value of each document is the same.

In a further embodiment the controller is further able to rank the documents in descending order of importance from the document that diffused the most value to the document that diffused the least value.

In a further embodiment, the links between the documents comprise one-way links.

Another embodiment is a method that includes acquiring a set of probabilities for documents that each indicate a likelihood of a user using a link at one document to view another document. The method also includes assigning an initial value to each document, and for each document that has a value greater than a cutoff amount, diffusing value from the document to other documents based on the set of probabilities. The method also includes ranking the documents based on an amount of value that was diffused from each document, and processing the documents based on their ranks.

Another embodiment is a non-transitory computer readable medium embodying programmed instructions which, when executed by a processor, are operable for performing a method. The method includes acquiring a set of probabilities for documents that each indicate a likelihood of a user using a link at one document to view another document. The method also includes assigning an initial value to each document, and for each document that has a value greater than a cutoff amount, diffusing value from the document to other documents based on the set of probabilities. The method also includes ranking the documents based on an amount of value that was diffused from each document, and processing the documents based on their ranks.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary linked system of documents of a network in an exemplary embodiment.

FIG. 2 is a block diagram that includes a ranking system in an exemplary embodiment.

FIG. 3 is a flowchart illustrating a method for operating a ranking system in an exemplary embodiment.

FIG. 4 is a flowchart illustrating additional details of operating a ranking system in an exemplary embodiment.

FIG. 5 is a block diagram illustrating an exemplary set of web pages.

FIG. 6 is a table summarizing various links between the web pages of FIG. 5.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

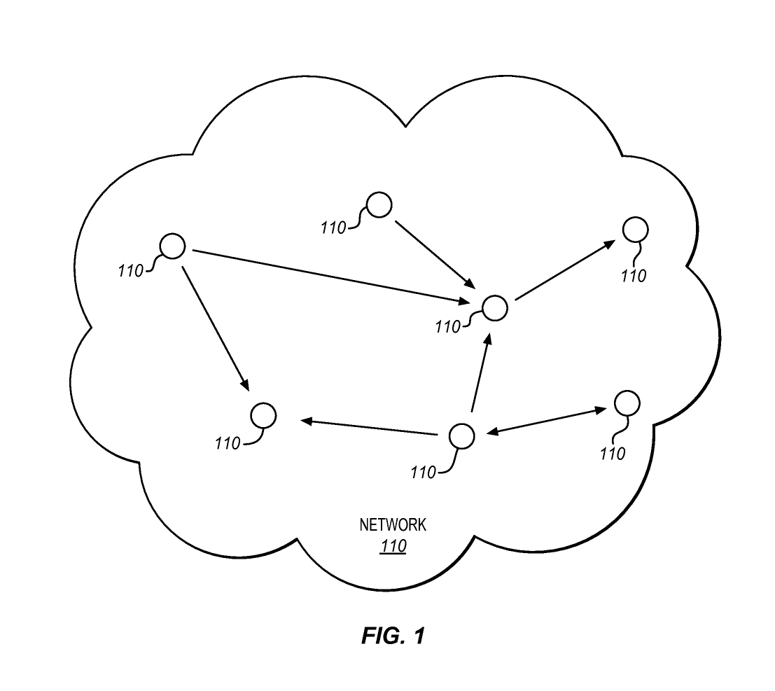

FIG. 1 is a block diagram of an exemplary linked system of documents 110 of a network 100 in an exemplary embodiment. As used herein, a document is a collection of digital content that can be viewed on a computer. This digital content can include text, graphics, and/or video. For example, a document could be a web page, an entire web site, an entry in a database, etc.

In FIG. 1, a variety of links exist between the documents. The information in each link allows a user to identify another document. Thus, when a user selects a link on one document, they can view a document that the link points to. For example, when the documents are web pages, links may comprise hyperlinks that enable a user's browser to “visit” other web pages. Thus, a user could select one link displayed at one web page in order to view another web page.

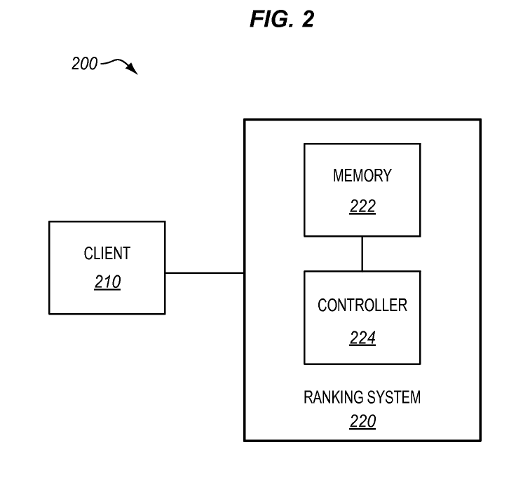

Determining the relative importance of documents such as web pages can be important, but present ranking techniques are unable to alleviate ranking problems caused by SEO techniques. To address these problems, ranking methods are implemented that can determine the importance of various linked documents based on the expected usage of links between those documents (e.g., “traffic” between the documents). Block diagram 200 of FIG. 2 illustrates an exemplary ranking system 220 that can be used to implement these methods. Ranking system 220 comprises any system, component, or device operable to model link usage between documents. In this embodiment, ranking system 220 includes memory 222 and controller 224.

Memory 222 comprises any system, component, or device operable to store information describing linked documents/nodes in a computer-readable format, while controller 224 comprises any system, device, or component operable to rank the documents based on the information stored in memory 222. Specifically, controller 224 has been enhanced to use a fluid/heat flow model of link usage in order to rank the documents.

Once the documents are ranked, the rankings can be provided in response to user queries from an electronic client 210. For example, if each document is a web page on the Internet, the rankings can help controller 224 to generate a sorted list of web pages for the user. Similarly, if each document is stored in memory 222 as a linked article, the rankings can be used by controller 224 to select an article to provide to the user. Controller 224 can be implemented, for example, as custom circuitry, as a processor of a server executing programmed instructions stored in an associated memory, or some combination thereof.

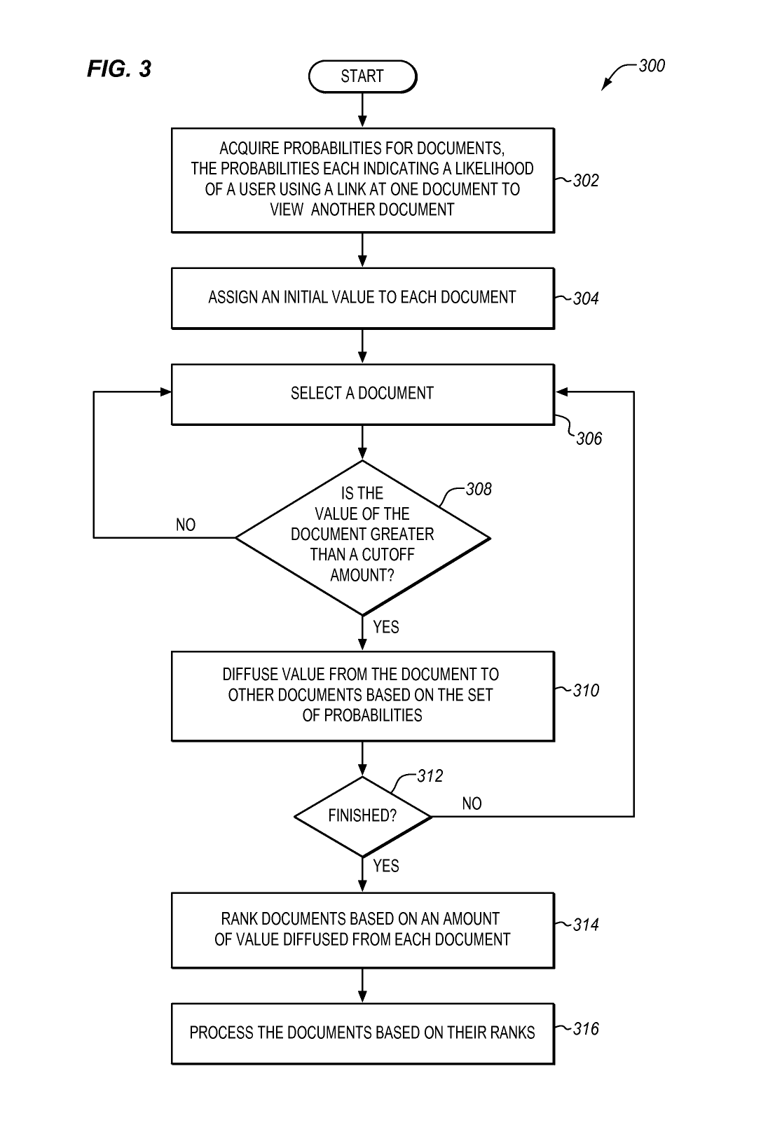

Further details of the operation of ranking system 220 will be discussed with regard to FIG. 3. Assume, for this embodiment, that memory 222 is currently storing data that describes a linked database of documents. The links between the documents can be used in order to view the documents.

FIG. 3 is a flowchart illustrating a method 300 for operating a ranking system in an exemplary embodiment. The steps of method 300 are described with reference to ranking system 220 of FIG. 2, but those skilled in the art will appreciate that method 300 may be performed in other systems. The steps of the flowcharts described herein are not all inclusive and may include other steps not shown. The steps described herein may also be performed in an alternative order.

In step 302, controller 224 acquires a set of probabilities from memory 222. Each probability indicates the likelihood of a user selecting a link at one document in order to view another document. For example, the probabilities can indicate the expected browsing patterns of users within a network of web pages.

In step 304, controller 224 assigns an initial value to each document. The initial value for each document is a placeholder that indicates the initial importance of each document. In one embodiment, each document is assigned the same initial value.

After the initial value has been assigned to each document, controller 224 attempts to model how that value will diffuse from each document to its peers. This “diffusion” technique is a way to model how users will follow the links on the documents to view other documents on the database. This diffusion concept rests on the notion that documents that generate more “hits” or “traffic” than their peers are more important than others.

To model the heat/fluid diffusion process, controller 224 selects an individual document (in step 306). Controller 224 then determines if the individual document has a value that is greater than a known cutoff amount in step 308. This cutoff amount may, for example, be the same or a lower value than the initial value assigned to each document.

If the value of the document is below the cutoff amount, then another document is selected in step 306. However, if the document has a value that is higher than the cutoff amount, then controller 224 diffuses the value for the document along its outgoing links to other documents in step 310, based on the probabilities. In one embodiment, controller 224 increases the value of each document that is linked to the current document, and then decreases the value of the current document (e.g., by the cutoff value). Thus, the value diffused from the current document can be conceptually modeled as heat traveling outward from the current document to its neighbors. The lost “heat” increases the value of the neighbors, while reducing the value of the current document.

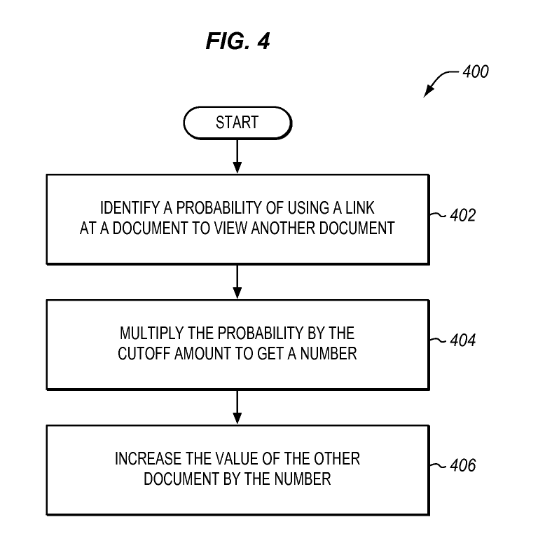

FIG. 4 is a flowchart 400 illustrating additional details of diffusing value between documents in an exemplary embodiment. According to FIG. 4, in order to diffuse value from a first document to a second document, controller 224 identifies a probability of using a link at the first document to view the second document in step 402. For example, the probability can be a decimal number between zero and one. Controller 224 then multiplies the probability by the cutoff value to determine a number in step 404. Controller 224 then increases the value of the second document by the number in step 406, while also reducing the value of the first document by the cutoff value.

In one embodiment, the diffusion is modeled with a damping factor. A damping factor makes it so that each time value is diffused from one document to the other, some value “leaks out” and is lost forever. For example, when the damping factor is 0.5, if a document loses X value to diffusion, only half of X in total value reaches the documents that are linked. This effectively leaks value out of the entire system, which makes the network of documents reduce in total value over time. When a damping factor is used, the process will eventually converge in a finite amount of time. This provides a benefit because a convergence time for the method can be more easily predicted than for alternate methods that may theoretically continue forever without converging. Furthermore, this is relevant with respect to step 312 described below.

The diffusion process can continue, and value can diffuse from multiple documents into other linked documents. Furthermore, if enough value enters a document, the document may again have a high enough value that the document diffuses again.

In step 312, controller 224 determines whether the diffusion process has finished. Typically, the process has finished when all of the documents have finally reached a value below the cutoff amount. For example, steps 306-310 can be performed for each document, and then iterated for the documents until all of the documents have a value that is below the cutoff amount. After the process has finished in step 312, controller 224 ranks the documents based on the amount of value that diffused from each document. Specifically, controller 224 may determine the amount of value that diffused out of each document during the processing of steps 306-310, and may then add this value to the current value of the document in order to determine a score. Controller 224 can then rank the documents in order of importance from highest score to lowest.

After the documents have been ranked, controller 224 can process the documents in step 316. For example, controller 224 may provide a ranked list of the documents to client 210.

Using the method described above, a document ranking system can be used that reduces the importance of documents that are self-linking with respect to their peers. Since little traffic flows into self-linking documents, method 300 will cause these documents to rapidly “cool” in value and lose importance. Thus, since method 300 ranks documents based on the amount of “hits” (modeled as heat) that they are expected to generate for other documents during normal operating conditions, it ranks documents in a new and previously unexpected manner.

### EXAMPLES

In the following examples, additional processes, systems, and methods are described in the context of a server having a controller that assigns ranks to web pages.

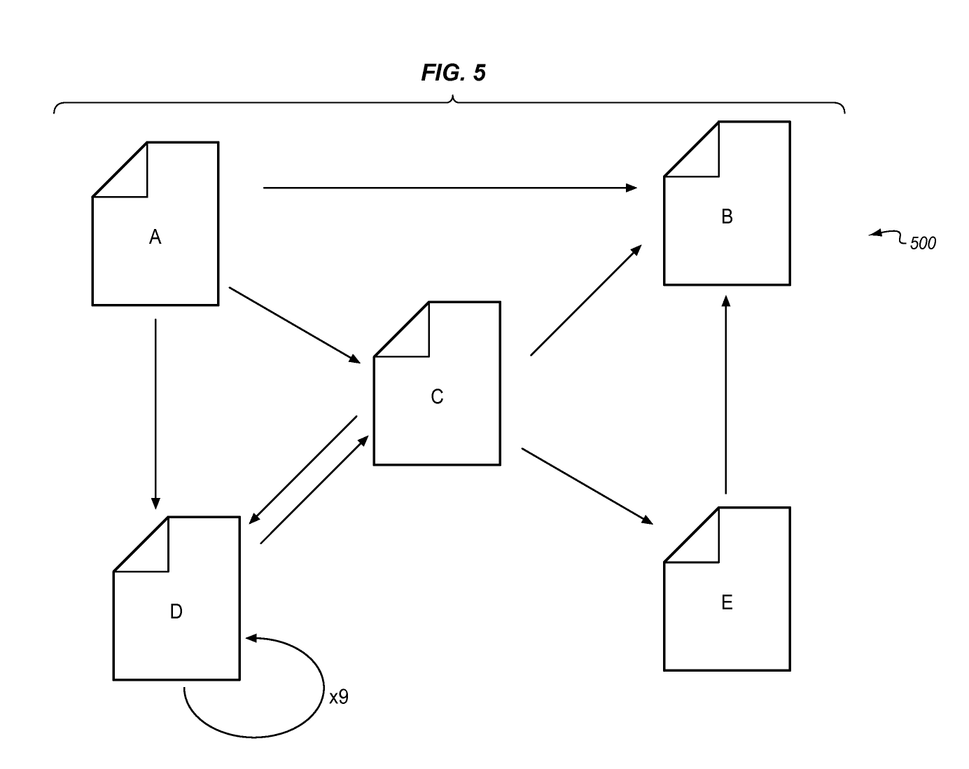

FIG. 5 is a block diagram 500 illustrating an exemplary set of web pages. According to FIG. 5, there are five different web pages. One web page (B) has no outgoing links, one web page (A) has no incoming links, and one web page (D) exhibits a large number of self-links. As used herein, each web page is also referred to interchangeably as a “node.”

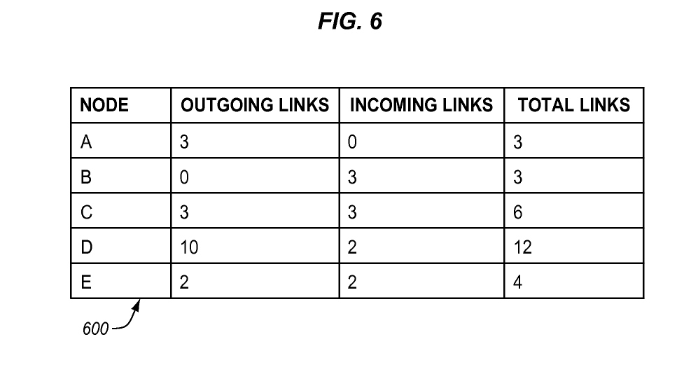

FIG. 6 is a table 600 summarizing various links between the web pages of FIG. 5. Based on table 600, if the web pages were ranked only based on the total number of links for each page, or based on the number of outgoing links for each page, web page D would be ranked highest, because of its large number of outgoing links which go back to page D. Thus, a cursory review of the web pages does not give a good indication of which web page is actually the most important with respect to its peers.

Assume for this embodiment that all of the web pages include keywords in a user's search query, and further assume that a server of a search engine (having an internal controller 224 and memory 222) is attempting to rank the importance of these relevant web pages to determine which ones to present to the user. To this end, controller 224 starts by accessing probability information stored in memory 222.

Memory 222 stores a probability matrix P₀ indicating the likelihood of a user using the links to view the web pages, shown below:

$${P}_{0} = \begin{matrix}A \\ B \\ C \\ D \\ E\end{matrix} {\{ \begin{matrix}0 & 0 & 0 & 0 & 0 \\ \frac{1}{3} & 0 & \frac{1}{3} & 0 & \frac{1}{2} \\ \frac{1}{3} & 0 & 0 & \frac{1}{10} & \frac{1}{2} \\ \frac{1}{3} & 0 & \frac{1}{3} & \frac{9}{10} & 0 \\ 0 & 0 & \frac{1}{3} & 0 & 0\end{matrix} \}}^{\begin{matrix}A & B & C & D & E\end{matrix}}$$

In P₀, a specific row is indicated with the letter i, while a column is represented with the letter j. Web page A corresponds to the first row/column, web page B corresponds to the second row/column, and so on. Furthermore, Pᵢⱼ indicates the likelihood of using a link from web page j to view web page i. In this example, the P₂₁ represents the likelihood of using a link from web page A to view web page B, and is ⅓, while P₃₄ represents the likelihood of using a link from website D to view website C, and is 1/10.

Web page B has no outgoing links, and thus there is no probability of using a link to view another web page from web page B. In this example where the number of web pages (N) is five, controller 224 normalizes the chances of viewing each web page from web page B by making all of these values in the probability matrix equal to 1/N (one fifth). This new probability matrix is shown below as P̅₀̅.

$$\overline{{P}_{0}} = \{ \begin{matrix}0 & \frac{1}{5} & 0 & 0 & 0 \\ \frac{1}{3} & \frac{1}{5} & \frac{1}{3} & 0 & 1 \\ \frac{1}{3} & \frac{1}{5} & 0 & \frac{1}{10} & 0 \\ \frac{1}{3} & \frac{1}{5} & \frac{1}{3} & \frac{9}{10} & 0 \\ 0 & \frac{1}{5} & \frac{1}{3} & 0 & 0\end{matrix} \}$$

After P̅₀̅ has been determined, controller 224 identifies a damping factor (D) stored in memory 222. The damping factor can be thought of as an amount of heat that leaves the system forever whenever temperature/value is diffused in the system. When D is low, the heat diffuses very quickly, meaning that the method converges on a rank for each node very quickly. However, larger values of D (closer to one) may be more desirable because although they take longer to converge, they are more accurate. In this example, D=0.5.

To generate the probability matrix that will be used to rank the nodes, controller 224 multiplies P̅₀̅ by D to get a matrix P, as shown below.

$$P = D * \overline{{P}_{0}} = \{ \begin{matrix}0 & \frac{1}{10} & 0 & 0 & 0 \\ \frac{1}{6} & \frac{1}{10} & \frac{1}{6} & 0 & \frac{1}{2} \\ \frac{1}{6} & \frac{1}{10} & 0 & \frac{1}{20} & 0 \\ \frac{1}{6} & \frac{1}{10} & \frac{1}{6} & \frac{9}{20} & 0 \\ 0 & \frac{1}{10} & \frac{1}{6} & 0 & 0\end{matrix} \}$$

As a further initialization step, controller 224 generates two vectors that each have a length of N (the number of nodes in the linked database). H₀ will be used to indicate the amount of heat that has diffused from a given node over time, and F₀ will be used to indicate the current temperature of a given node. In this example, H₀ is initialized to zeroes, while F₀ is initialized to ones, as shown below.

$${H}_{0} = \{ \begin{matrix}0 \\ 0 \\ 0 \\ 0 \\ 0\end{matrix} \} {F}_{0} = \{ \begin{matrix}1 \\ 1 \\ 1 \\ 1 \\ 1\end{matrix} \}$$

Controller 224 also determines that the cutoff amount (CUT_AMT, stored in memory 222) to be used in the ranking system is equal to one.

Controller 224 then starts to perform its process of diffusing heat from the web pages. For the first web page A, controller 224 diffuses temperature to other web pages based on P and the cutoff value. Specifically, each other web page i is heated by an amount equal to Pᵢ₁*CUT_AMT, and web page A drops in temperature by CUT_AMT. Thus, after computing heat diffusion from node A, it can be seen that nodes B, C, and D each increase in temperature by a value of ⅙ (i.e., 0.1 6̅). Meanwhile, the entry for node A is increased in H by the amount of heat that has left node A.

$${H}_{1} = \{ \begin{matrix}1 \\ 0 \\ 0 \\ 0 \\ 0\end{matrix} \} {F}_{1} = \{ \begin{matrix}0 \\ 1.1 \overline{6} \\ 1.1 \overline{6} \\ 1.1 \overline{6} \\ 1\end{matrix} \}$$

A similar process is performed for node B. Specifically, each other web page i is heated by an amount equal to Pᵢ₂*CUT_AMT, and web page B drops in temperature by CUT_AMT. This means that each other node increases in temperature by 1/10.

$${H}_{2} = \{ \begin{matrix}1 \\ 1 \\ 0 \\ 0 \\ 0\end{matrix} \} {F}_{2} = \{ \begin{matrix}0.1 \\ 0.2 \overline{6} \\ 1.2 \overline{6} \\ 1.2 \overline{6} \\ 1.1\end{matrix} \}$$

Additionally, a similar process is performed for node C. Specifically, each other web page i is heated by an amount equal to Pᵢ₃*CUT_AMT, and web page C drops in temperature by CUT_AMT (one). This means that the temperature of web pages B, D, and E each increases by ⅙.

$${H}_{3} = \{ \begin{matrix}1 \\ 1 \\ 1 \\ 0 \\ 0\end{matrix} \} {F}_{3} = \{ \begin{matrix}0 \\ 0.4 \overline{3} \\ 0.2 \overline{6} \\ 1.4 \overline{3} \\ 1.2 \overline{6}\end{matrix} \}$$

Further, a similar process is performed for node D, increasing the temperature of web page C by 1/20, and the temperature of web page D by 9/20.

$${H}_{4} = \{ \begin{matrix}1 \\ 1 \\ 1 \\ 1 \\ 0\end{matrix} \} {F}_{4} = \{ \begin{matrix}0 \\ 0.4 \overline{3} \\ 0.32 \\ 0.88 \\ 1.2 \overline{6}\end{matrix} \}$$

Also, a similar process is also performed for node E, increasing the temperature of web page B by ½.

$${H}_{5} = \{ \begin{matrix}1 \\ 1 \\ 1 \\ 1 \\ 1\end{matrix} \} {F}_{5} = \{ \begin{matrix}0 \\ 0.9 \overline{3} \\ 0.32 \\ 0.88 \\ 0.2 \overline{6}\end{matrix} \}$$

At this point, there are no nodes that remain in the system that still have a temperature above the cutoff value of one, so the process terminates. However, if any nodes still had such an amount left, the process could continue on.

To attain a final ranking, controller 224 adds back in the amount of heat that left each node to the current temperature of each node, as shown below.

$${H}_{5} + {F}_{5} = \{ \begin{matrix}1 \\ 1.9 \overline{3} \\ 1.32 \\ 1.88 \\ 1.2 \overline{6}\end{matrix} \}$$

Thus, the nodes, ranked in order, are B, D, C, E, A. Web page D has twelve total links, but its ranking value (1.88) is actually less than B, because the value of the nine self-links are substantially discounted. This method therefore reduces the impact of self-linking on page ranking mechanisms. Controller 224 then identifies web page B as the most important relevant web page for the user's search request, and transmits the internet address of web page B to the user so that the user may use a link to view web page B.

Any of the various elements shown in the figures or described herein may be implemented as hardware, software, firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a memory that stores probabilities for documents that each indicate a likelihood of using a link at a document to view another document; and
a controller operable to assign an initial value to each document, and for each document that has a value greater than a cutoff amount, to diffuse the value from the document to other documents based on the probabilities,
the controller is operable to rank the documents based on an amount of value that was diffused from each document, and to process the documents based on their ranks.

2. The system of claim 1, wherein:
the controller is further operable to diffuse value from a document by reducing the value of the document by the cutoff amount, and increasing values of documents linked to the document by a total that is not greater than the cutoff amount.

3. The system of claim 2, wherein:
the controller is further operable to iteratively repeat diffusing value from the documents until each document has a value less than the cutoff amount.

4. The system of claim 1, wherein:
the controller is operable to diffuse the value from the document to other documents by:
reducing the value of the document by the cutoff amount; and
for each other document:
identifying a probability of using a link at the document to view the other document, and increasing the value of the other document by the probability multiplied by the cutoff amount.

5. The system of claim 1, wherein:
the sum total of the probabilities of using a link at a document to view each other document add up to a value of less than or equal to one.

6. The system of claim 1, wherein:
the initial value of each document is the same.

7. The system of claim 1, wherein:
the controller is further operable to rank the documents in descending order of importance from the document that diffused the most value to the document that diffused the least value.

8. The system of claim 1, wherein:
the links between the documents comprise one-way links.

9. A method comprising:
acquiring a set of probabilities for documents that each indicate a likelihood of a user using a link at one document to view another document;
assigning an initial value to each document;
for each document that has a value greater than a cutoff amount, diffusing value from the document to other documents based on the set of probabilities;
ranking the documents based on an amount of value that was diffused from each document; and
processing the documents based on their ranks.

10. The method of claim 9, further comprising:
diffusing value from a document by reducing the value of the document by the cutoff amount, and increasing values of documents linked to the document by a total that is not greater than the cutoff amount.

11. The method of claim 10, further comprising:
iteratively repeating diffusing value from the documents until each document has a value less than the cutoff amount.

12. The method of claim 9, further comprising diffusing the value from the document to other documents by:
reducing the value of the document by the cutoff amount; and
for each other document:
identifying a probability of using a link at the document to view the other document; and
increasing the value of the other document by the probability multiplied by the cutoff amount.

13. The method of claim 9, wherein:
the sum total of the probabilities of using a link at a document to view each other document add up to a value of less than or equal to one.

14. The method of claim 9, wherein:
the initial value of each document is the same.

15. The method of claim 9, further comprising:
ranking the documents in descending order of importance from the document that diffused the most value to the document that diffused the least value.

16. The method of claim 9, wherein:
the links between the documents comprise one-way links.

17. A non-transitory computer readable medium embodying programmed instructions which, when executed by a processor, are operable for performing a method comprising:
acquiring a set of probabilities for documents that each indicate a likelihood of a user using a link at one document to view another document;
assigning an initial value to each document;
for each document that has a value greater than a cutoff amount, diffusing value from the document to other documents based on the set of probabilities;
ranking the documents based on an amount of value that was diffused from each document; and
processing the documents based on their ranks.

18. The medium of claim 17, wherein the method further comprises:
diffusing value from a document by reducing the value of the document by the cutoff amount, and increasing values of documents linked to the document by a total that is not greater than the cutoff amount.

19. The medium of claim 18, wherein the method further comprises:
iteratively repeating diffusing value from the documents until each document has a value less than the cutoff amount.

20. The medium of claim 17, wherein the method further comprises diffusing the value from the document to other documents by:
reducing the value of the document by the cutoff amount; and
for each other document:
identifying a probability of using a link at the document to view the other document; and
increasing the value of the other document by the probability multiplied by the cutoff amount.
